(19) United States
(12) Patent Application Publication
(10) Pub. No.: US 2013/0013421 A1
(43) Pub. Date: Jan. 10, 2013

(54) METHODS AND SYSTEMS FOR COLLABORATIVE ADVERTISING

(75) Inventors: Shrutivandana Sharma, Bangalore (IN); Sachin Garg, Bangalore (IN)

(73) Assignee: Yahoo! Inc., Sunnyvale, CA (US)

(21) Appl. No.: 13/178,266

(22) Filed: Jul. 7, 2011

(51) Int. Cl. G06Q 30/00

(52) U.S. Cl. 705/14.71; 705/14.73

(57) ABSTRACT

Methods and systems are disclosed in which a guaranteed delivery advertisement may be appended with a non-guaranteed delivery advertisement. The guaranteed delivery advertisement may be, for example, a manufacturer or brand advertisement, and the non-guaranteed delivery advertisement may be, for example, a retailer advertisement. The guaranteed delivery advertisement may relate to a particular brand and/or product and the non-guaranteed delivery advertisement may relate to a purchasing opportunity for that particular brand and/or product. The guaranteed delivery advertisement may be selected based on targeting information and the non-guaranteed delivery advertisement may be selected based on factors such as, for example, the manufacturer name, the product name, the product type, a related product, price, availability of the product, discount, location of the retailer, etc.

### BACKGROUND

Online advertising marketplaces and exchanges may involve, for example, entities or parties including advertisers, publishers and data providers, as well as a marketplace or online advertising operations facilitator, or market-maker. Data providers may supply information, such as information regarding users, user behavior or user interests, which may enhance value to advertisers in connection with purchasing of advertising inventory. However, in marketplaces and exchanges, significant difficulty and transactional friction may exist in selectivity, arrangements and cooperation between parties. This can lead to suboptimal interactions, reducing efficiency and disincentivizing maximum engagement and spending. Furthermore, friction as well as inequities or unfairness may exist in connection with pricing arrangement, actual pricing, and allocation of spend between parties including advertisers and data providers, and such as in connection with sold advertising inventory.

There is a need for improved techniques in online advertising, including in online advertising marketplaces and exchanges.

### SUMMARY

Some embodiments of the invention provide systems and methods in which a guaranteed delivery advertisement may be appended with one or more non-guaranteed delivery advertisements. The guaranteed delivery advertisement may be, for example, a manufacturer or brand advertisement, and the non-guaranteed delivery advertisement(s) may be, for example, a retailer advertisement. The guaranteed delivery advertisement may relate to a particular brand and/or product and the non-guaranteed delivery advertisement may(s) relate to a purchasing opportunity for that particular brand and/or product. As will be understood by one of ordinary skill in the art, in a guaranteed delivery advertising model, advertisers may pay based on an agreement (e.g., a contract) which guarantees or provides some measure of assurance that the advertiser will receive a certain agreed upon amount of suitable advertising. For example, the agreement may provide that the advertisement will have one million views. By contrast, non-guaranteed delivery advertising models may be based on individual serving opportunities or may be spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

In some embodiments, a guaranteed delivery advertisement which relates to a brand or product is selected and one or more corresponding non-guaranteed delivery advertisement(s) may be subsequently selected based on the guaranteed delivery advertisement. The guaranteed delivery advertisement may be selected based on targeting information such as, for example, user location, age, demographic, user profile information, search history, browse history, etc. In some embodiments the non-guaranteed delivery advertisement(s) may be selected based on factors such as, for example, the manufacturer name, the product name, the product type, a related product, price, availability of the product, discount, location of the retailer, etc.

The guaranteed delivery advertisement and the non-guaranteed delivery advertisement(s) may be served substantially simultaneously. In some embodiments, the guaranteed delivery advertisement and non-guaranteed delivery advertisement(s) may be displayed adjacent to each other.

In some embodiments a group of advertisements comprising a guaranteed delivery advertisement and one or more non-guaranteed delivery advertisements may be selected together. The guaranteed delivery advertisement may relate to a brand or product and the non-guaranteed delivery advertisement(s) may relate to a purchase opportunity related to the brand or product. The guaranteed delivery advertisement and the non-guaranteed delivery advertisement(s) may be selected together based at least in part on bids submitted in an auction based marketplace by guaranteed delivery advertisers and non-guaranteed delivery advertisers.

In some embodiments, the guaranteed delivery advertisers may submit bids indicating the price they are willing to pay to have their guaranteed delivery advertisements served. Similarly, the non-guaranteed delivery advertisers may submit bids indicating the price they are willing to pay to have their non-guaranteed delivery advertisements paired with the guaranteed delivery advertisements.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is an exemplary webpage illustrating collaborative advertisements according to one embodiment of the invention.

### DETAILED DESCRIPTION

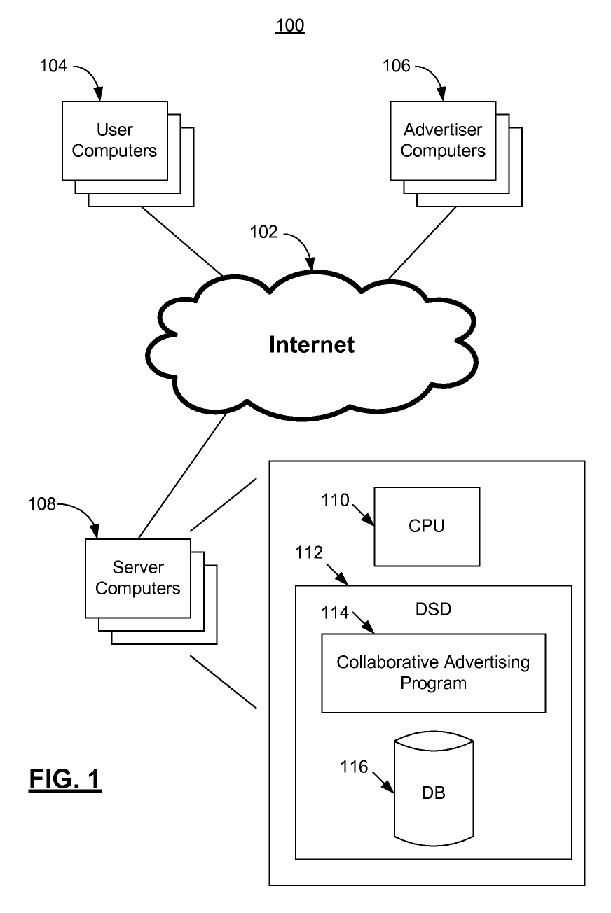

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Collaborative Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

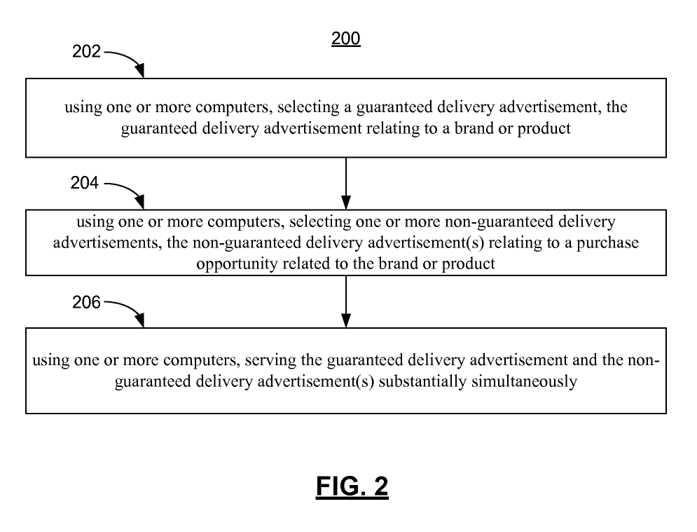

FIG. 2 is a flow diagram illustrating a method 200 according to one embodiment of the invention. At step 202, using one or more computers, a guaranteed delivery advertisement which relates to a brand or product is selected. The advertisement may be for example, an advertisement for Pepsi®. As will be understood by one of ordinary skill in the art, in a guaranteed delivery advertising model, advertisers may pay based on an agreement (e.g., a contract) which guarantees or provides some measure of assurance that the advertiser will receive a certain agreed upon amount of suitable advertising. For example, the agreement may provide that the advertisement will have one million views. By contrast, non-guaranteed delivery advertising models may be based on individual serving opportunities or may be spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics. The guaranteed delivery advertisements may be selected based on targeting information such as, for example, user location, age, demographic, user profile information, search history, browse history, etc. The guaranteed delivery and non-guaranteed delivery advertisements may be selected by one or more advertiser computers 106 (FIG. 1), by one or more server computers 108 (FIG. 1), or in combination by one or more server computers 108 and one or more advertiser computers 106.

At step 204, using one or more computers, one or more non-guaranteed delivery advertisements which relate to a purchase opportunity related to the brand or product may be selected. Using the above example, the advertisement may be for a retailer that sells Pepsi® products. In some embodiments the non-guaranteed delivery advertisement(s) may be selected based on factors such as, for example, the manufacturer name, the product name, the product type, a related product, price, availability of the product, discount, location of the retailer, etc.

At step 206, using one or more computers, the guaranteed delivery advertisement and the non-guaranteed delivery advertisement(s) are served substantially simultaneously. In some embodiments, the guaranteed delivery advertisement and non-guaranteed delivery advertisement(s) may be displayed adjacent to each other.

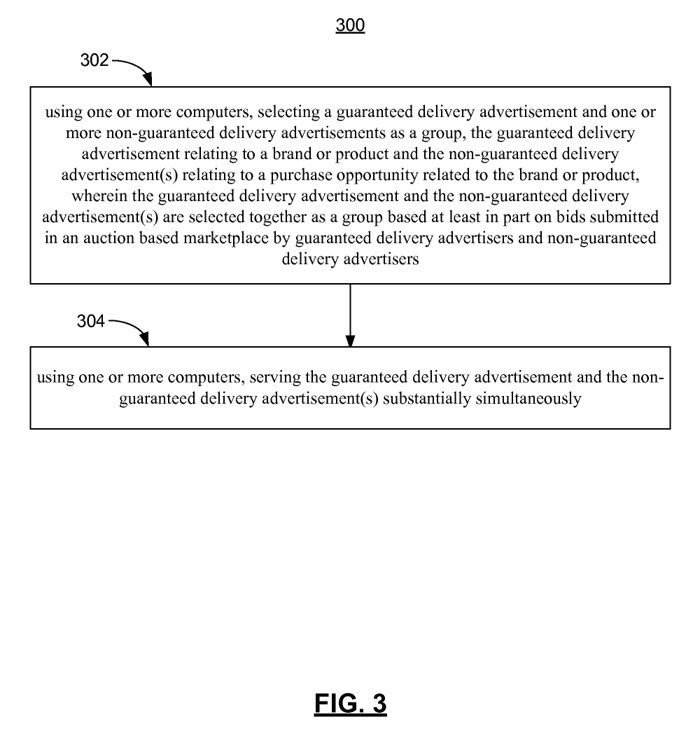

FIG. 3 is a flow diagram illustrating a method 300 according to one embodiment of the invention. At step 302, using one or more computers, a group of advertisements comprising a guaranteed delivery advertisement and one or more non-guaranteed delivery advertisements are selected. The guaranteed delivery advertisement relates to a brand or product and the non-guaranteed delivery advertisement(s) relates to a purchase opportunity related to the brand or product, wherein the guaranteed delivery advertisement and the non-guaranteed delivery advertisement(s) are selected together based at least in part on bids submitted in an auction based marketplace by guaranteed delivery advertisers and non-guaranteed delivery advertisers.

At step 304, using one or more computers, the guaranteed delivery advertisement and the non-guaranteed delivery advertisement(s) are served substantially simultaneously. In various embodiments, including that depicted in FIG. 3, the guaranteed delivery and non-guaranteed delivery advertisements may include textual, graphical, audio, video and/or link data. In some embodiments, the advertisements may be served from one or more advertiser computers 106 (FIG. 1) and/or one or more server computers 108 (FIG. 1).

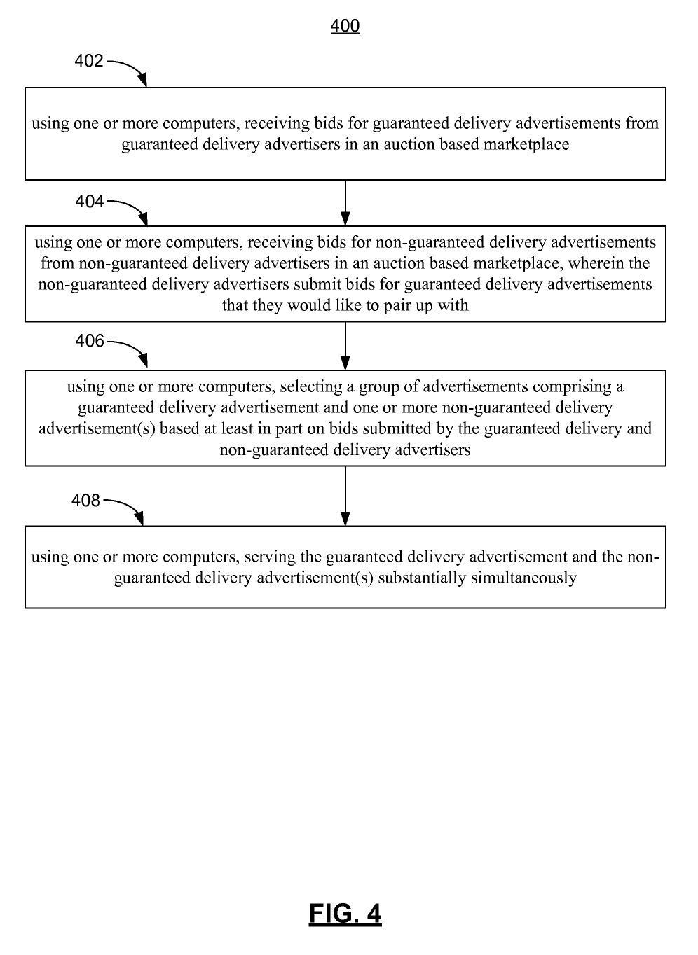

FIG. 4 is a flow diagram illustrating a method 400 according to one embodiment of the invention. At step 402, using one or more computers, bids for guaranteed delivery advertisements are received from guaranteed delivery advertisers in an auction based marketplace. The guaranteed delivery advertisers may submit bids indicating the price they are willing to pay to have their guaranteed delivery advertisements served. Guaranteed delivery advertisers may include, for example, manufacturers.

At step 404, using one or more computers, bids for non-guaranteed delivery advertisements are received from non-guaranteed delivery advertisers in an auction based marketplace, wherein the non-guaranteed delivery advertisers submit bids for guaranteed delivery advertisements that they would like to pair up with. In other words, the non-guaranteed delivery advertisers may submit bids indicating the price they are willing to pay to have their non-guaranteed delivery advertisements paired with the guaranteed delivery advertisements. Non-guaranteed delivery advertisers may include, for example, retailers.

At step 406, using one or more computers, a group of advertisements comprising a guaranteed delivery advertisement and one or more non-guaranteed delivery advertisement(s) is selected based at least in part on bids submitted by the guaranteed delivery and non-guaranteed delivery advertisers. In some embodiments, each guaranteed delivery and non-guaranteed delivery advertisement(s) group may be assigned a score based in part on the submitted bids for each advertisement. Alternatively, or in addition, the score may be assigned based on other factors such as, expected revenue to the publisher (e.g., Yahoo) from the advertisement group, the total expected value of the advertisement group to the corresponding advertisers, etc. In some embodiments, the group of advertisements comprising a guaranteed delivery advertisement and one or more non-guaranteed delivery advertisement(s) may selected together or serially (e.g., first select the guaranteed delivery advertisement and subsequently select one or more non-guaranteed delivery advertisements). It should be noted that serial selection may allow for higher revenue, but selecting the advertisements together may allow for better association or matching. In some embodiments, guaranteed delivery advertisers may receive a discount because the guaranteed delivery advertisements may enhance the performance of the non-guaranteed delivery advertisements. In other words, the enhanced performance of the non-guaranteed delivery advertisements (as a result of being paired with guaranteed delivery advertisements) may be used to subsidize guaranteed delivery advertisements.

At step 408, using one or more computers, the group comprising the guaranteed delivery advertisement and the non-guaranteed delivery advertisement(s) is served substantially simultaneously. In some embodiments, the group with the highest assigned score may be served.

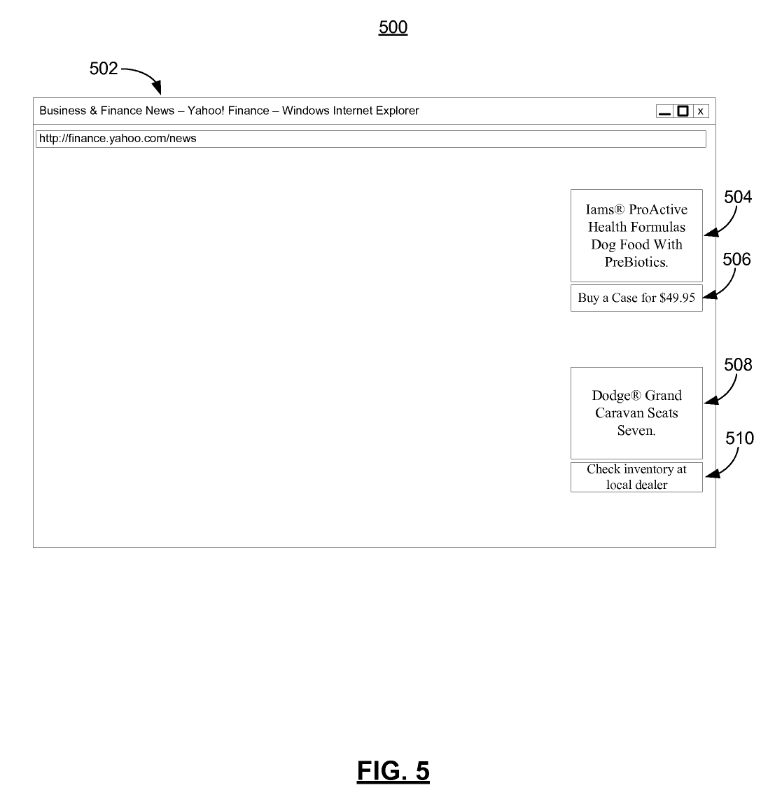

FIG. 5 illustrates an exemplary web page 502 according to one embodiment of the invention. Web page 502 depicts two pairs of collaborative advertisements. One pair comprises advertisement 504 and advertisement 506. Advertisement 504 may be a guaranteed delivery advertisement and advertisement 506 may be a non-guaranteed delivery advertisement. As shown in FIG. 5, advertisement 504 represents a manufacturer advertisement and advertisement 506 represents a retail advertisement. Retail advertisement 506 may be for a retailer that is local to the user (e.g., Walmart) or may be for an online retailer. Similarly, advertisement 508 and advertisement 510 make up the second pair of collaborative advertisements. Although two pairs of advertisements are shown in the exemplary web page 502, any number of pairs of advertisements may be displayed on the web page. Further, although one corresponding non-guaranteed delivery advertisement is displayed with one guaranteed delivery advertisement, a plurality of corresponding non-guaranteed delivery advertisements may be displayed with a guaranteed delivery advertisement. Moreover, although the retail advertisements are displayed adjacent to the corresponding manufacturer advertisements, the retail advertisements may be displayed anywhere on the webpage. However, displaying the guaranteed delivery and non-guaranteed delivery advertisements adjacent to each other may enhance performance of the advertisements (e.g., increase revenue).

In accordance with exemplary embodiments, guaranteed delivery advertisements may be appended with one or more non-guaranteed delivery advertisements. The guaranteed delivery advertisements may include, for example, brand or manufacturer advertisements and the non-guaranteed advertisements may include, for example, retailer advertisements. As shown in the exemplary webpage illustrated in FIG. 5, a user who is influenced by brand or manufacturer advertisement 504, may immediately click on the appended retailer advertisement 506 to be presented with a purchase opportunity.

In some embodiments, the guaranteed delivery advertisement (e.g., the brand or manufacturer advertisement) may be selected from an advertisement inventory based on various user targeting criteria such as location, search history, browse history, etc. The non-guaranteed delivery advertisement(s) (e.g., a retailer advertisement) may subsequently be selected based on the selected guaranteed delivery advertisement. For example, the non-guaranteed advertisement(s) may be paired with the guaranteed delivery advertisement based on the manufacturer name, the product or brand name, the product type, price of the product, availability of the product, discount, location of the retailer, etc. Alternatively, or in addition, the non-guaranteed delivery advertisement(s) may be selected based on the likelihood of click/conversion by a user when displayed together with the selected guaranteed delivery advertisement. In some embodiments, the non-guaranteed delivery advertisement(s) which is likely to maximize revenue for the publisher when paired with the selected guaranteed delivery advertisement may be selected.

In some embodiments, an auction based bidding system may be used to select non-guaranteed delivery advertisement(s) to pair with a selected guaranteed delivery advertisement. For example, non-guaranteed delivery advertisers may submit bids that represent the maximum amount they are willing to pay for each click/conversion obtained through the collaborative advertisement (e.g., the guaranteed delivery and non-guaranteed delivery advertisement pair). The per click/conversion payment for each non-guaranteed delivery advertiser may then be determined based on the bids submitted by other non-guaranteed delivery advertisers. In one embodiment, a non-guaranteed delivery advertiser may bid different amounts corresponding to different guaranteed delivery advertisers. For example, a Target store may submit a “cost-per-click” bid of $0.30 for Pepsi and $0.50 for Coke. So, if a Pepsi advertisement is selected as the guaranteed delivery advertisement, and is appended with the Target ad, the per click payment for Target would be determined based on its bid of $0.30. In yet another bidding scheme, non-guaranteed delivery advertisers may submit their bids after a guaranteed delivery advertiser has been selected by the system. In this case, the non-guaranteed delivery advertiser already knows that the Pepsi® ad is being served and thus, may account for this information while bidding.

In some embodiments, the guaranteed delivery and non-guaranteed delivery advertisements may be selected together as a pair based on the bids submitted by both guaranteed delivery and non-guaranteed delivery advertisers. The guaranteed delivery advertisers may submit their bids for cost per impression (e.g., cost per million or CPM). The non-guaranteed delivery advertisers may submit their cost per click bids corresponding to each guaranteed delivery advertisement that they are willing to pair up with. For example, a Target store may submit a cost per click bid of $0.30 for Pepsi and $0.50 for Coke. Based on the submitted bids, each possible guaranteed delivery and non-guaranteed delivery advertisement pair may be assigned a score. The assignment of this score may be based on factors such as, expected revenue to publisher from the advertisement pair, the total expected value of the advertisement pair to the corresponding advertisers, etc. When an ad call comes, the pair with the highest score may be served to the user.

Although the previously discussed embodiments disclose matching a guaranteed delivery advertisement (e.g., a brand or manufacturer advertisement) with one or more non-guaranteed delivery advertisements (e.g., retail advertisements), in some embodiments, non-guaranteed delivery advertisements which may be brand or manufacturer advertisements may be matched with other non-guaranteed delivery advertisements which may be for example, retail advertisements. In other words, non-guaranteed delivery advertisements need not be limited to retail or purchasing opportunity advertisements, they may also be brand or manufacturer advertisements, and may thus be matched other non-guaranteed delivery advertisements which may be retail or purchasing opportunity advertisements.

While the invention is described with reference to the above drawings, the drawings are intended to be illustrative, and the invention contemplates other embodiments within the spirit of the invention.

1. A method comprising:
using one or more computers, selecting a guaranteed delivery advertisement, the guaranteed delivery advertisement relating to a brand or product;
using one or more computers, selecting a non-guaranteed delivery advertisement, the non-guaranteed delivery advertisement relating to a purchase opportunity related to the brand or product; and
using one or more computers, serving the guaranteed delivery advertisement and the non-guaranteed delivery advertisement substantially simultaneously.

2. The method of claim 1 further comprising:
using one or more computers, displaying the guaranteed delivery advertisement and the non-guaranteed delivery advertisement substantially simultaneously.

3. The method of claim 2, wherein the guaranteed delivery advertisement and the non-guaranteed delivery advertisement are displayed adjacent to each other.

4. The method of claim 1, wherein the non-guaranteed delivery advertisement is selected based at least in part on the guaranteed delivery advertisement.

5. The method of claim 1, wherein the guaranteed delivery advertisement and the non-guaranteed delivery advertisement are selected together as a pair.

6. The method of claim 1, wherein the guaranteed delivery advertisement is selected to fulfill a guaranteed delivery contract.

7. The method of claim 1, wherein the non-guaranteed delivery advertisement is a spot market advertisement.

8. The method of claim 7, wherein the non-guaranteed delivery advertisement is selected in an auction based marketplace.

9. The method of claim 5, wherein the guaranteed delivery advertisement and the non-guaranteed delivery advertisement are selected together as a pair based at least in part on bids submitted in an auction based marketplace by guaranteed delivery advertisers and non-guaranteed delivery advertisers.

10. A system comprising:
one or more server computers coupled to a network; and
one or more databases coupled to the one or more server computers;
wherein the one or more server computers are for:
selecting a guaranteed delivery advertisement, the guaranteed delivery advertisement relating to a brand or product;
selecting a non-guaranteed delivery advertisement, the non-guaranteed delivery advertisement relating to a purchase opportunity related to the brand or product; and
serving the guaranteed delivery advertisement and the non-guaranteed delivery advertisement substantially simultaneously.

11. The system of claim 1 wherein the one or more server computers are further configured for:
displaying the guaranteed delivery advertisement and the non-guaranteed delivery advertisement substantially simultaneously.

12. The system of claim 11, wherein the guaranteed delivery advertisement and the non-guaranteed delivery advertisement are displayed adjacent to each other.

13. The system of claim 10, wherein the non-guaranteed delivery advertisement is selected based at least in part on the guaranteed delivery advertisement.

14. The system of claim 10, wherein the guaranteed delivery advertisement and the non-guaranteed delivery advertisement are selected together as a pair.

15. The system of claim 10, wherein the guaranteed delivery advertisement is selected to fulfill a guaranteed delivery contract.

16. The system of claim 10, wherein the non-guaranteed delivery advertisement is a spot market advertisement.

17. The system of claim 16, wherein the non-guaranteed delivery advertisement is selected in an auction based marketplace.

18. The system of claim 14, wherein the guaranteed delivery advertisement and the non-guaranteed delivery advertisement are selected together as a pair based at least in part on bids submitted in an auction based marketplace by guaranteed delivery advertisers and non-guaranteed delivery advertisers.

19. The system of claim 18, wherein the non-guaranteed delivery advertisers submit bids for guaranteed delivery advertisements which they would like to pair with non-guaranteed delivery advertisements.

20. A computer readable medium or media containing instructions for executing a method comprising:
using one or more computers, selecting a guaranteed delivery advertisement and a non-guaranteed delivery advertisement as a pair, the guaranteed delivery advertisement relating to a brand or product and the non-guaranteed delivery advertisement relating to a purchase opportunity related to the brand or product;
wherein the guaranteed delivery advertisement and the non-guaranteed delivery advertisement are selected together as a pair based at least in part on bids submitted in an auction based marketplace by guaranteed delivery advertisers and non-guaranteed delivery advertisers; and
using one or more computers, serving the guaranteed delivery advertisement and the non-guaranteed delivery advertisement substantially simultaneously.
